(19) United States
(12) Patent Application Publication
(10) Pub. No.: US 2012/0279744 A1
(43) Pub. Date: Nov. 8, 2012

(54) High Efficiency Ground Electrode

(75) Inventor: Mauro Pedraza Garcia, De Jalisco (MX)

(73) Assignee: GREEN INNOVATIONS HOLDING LLC, Dallas, TX (US)

(21) Appl. No.: 13/101,001

(22) Filed: May 4, 2011

(51) Int. Cl. H01R 4/66

(52) U.S. Cl. 174/6

(57) ABSTRACT

A ground electrode includes a base plate having an upper and a lower side. The ground electrode includes a plurality of tubes each having a first and a second end. The first ends of the tubes are connected to the lower side of the base plate. The tubes are tilted so that the second ends converge in the circular base of a cone. An admittance coupler is attached to the upper side of the base plate. The admittance coupler includes a body plate electrically connected to the base plate. Two arm plates and a head plate are connected to the body plate. The ground electrode includes a plurality of diffusers each circumferentially wrapping a section of a respective tube.

### TECHNICAL FIELD

The invention relates generally to ground electrodes.

### BACKGROUND

A ground electrode is a conductor which connects buildings, structures and electrical systems to ground (earth). Buildings, structures and electrical systems may be connected to ground by a ground electrode for several reasons. The ground electrode limits the build-up of static electricity in buildings and structures. Also, the ground electrode limits high voltages imposed by lightning and line surges. By providing a path for fault current to flow to ground, the ground electrode improves safety conditions for humans and systems.

### SUMMARY

The embodiments of the invention provide a ground electrode that has a base plate having an upper and a lower side. The ground electrode includes a plurality of tubes each having a first and a second end. The first ends are connected to the lower side of the base plate. The tubes are tilted so that the second ends converge in the base of a cone or a pyramid.

The ground electrode includes an admittance coupler attached to the upper side of the base plate. The admittance coupler has a body plate electrically connected to the base plate. Two arm plates and a head plate are connected to the body plate. The ground electrode includes a plurality of diffusers, each circumferentially wrapping a section of a respective tube.

The base plate may have a triangular, rectangular, circular, or any other suitable shape. The diffusers may be frustum-shaped or ring-shaped, or the diffusers may have any other suitable shape. The diffusers are formed of a conductive material.

In one embodiment, the two arm plates and the head plate each has a threaded throughbore for receiving a respective threaded rod. In one embodiment, each tube is connected to one of the vertices of the base plate. The base plate may be made from copper or a suitable conductive material. In one embodiment, the body plate is connected to the base plate via a conductive rod.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a ground electrode in accordance with one embodiment of the invention.

FIGS. 2A and 2B illustrate an admittance coupler.

FIG. 3 illustrates a side view of the ground electrode.

### DETAILED DESCRIPTION

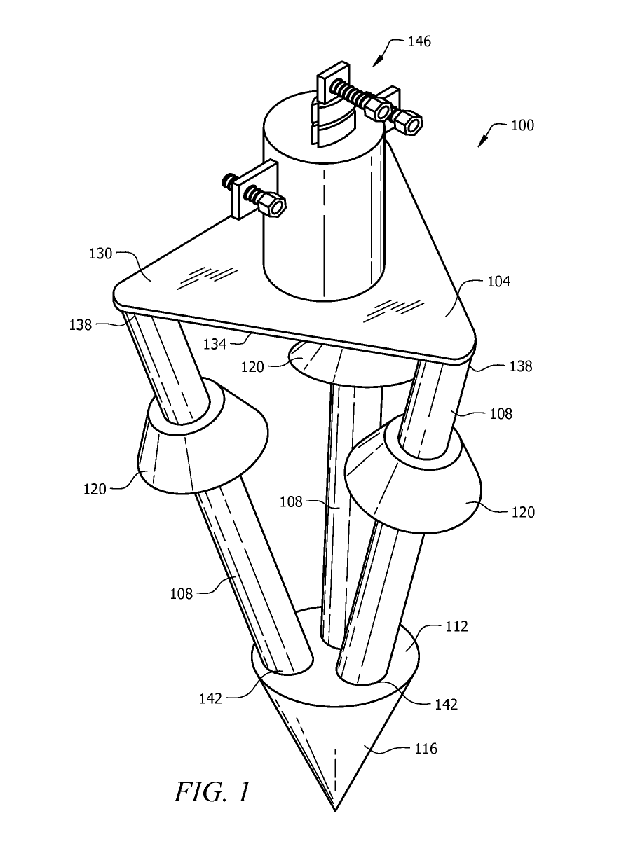

FIG. 1 illustrates a ground electrode 100 in accordance with one embodiment of the invention. The ground electrode 100 includes a base plate 104 having an upper and a lower side 130 and 134. In one embodiment, the base plate 104 is triangular. The base plate 104 may be made from copper or any other suitable conductive material. The edges of the base plate 100 may be rounded. The base plate 100 may have other suitable shapes (e.g., rectangular, circular, etc.). In one embodiment, the base plate 104 is positioned approximately parallel to the ground.

In one embodiment, the ground electrode 100 includes three tubes 108, each having a first and a second end 138 and 142. The first ends 138 are connected to the lower side 134 of the base plate 104. The tubes 138 are tilted so that the second ends 142 converge in the circular base 112 of a cone 116. A pyramid or any other suitable structural element may be utilized instead of the cone.

In one embodiment, the tubes 108 are solid and are made from a conductive material such as copper. In another embodiment, the tubes 108 are hollow. In one embodiment, the cone 116 is solid and is made from copper. The first end 138 of the tubes 108 are preferably connected proximate to the corners of the base plate 104.

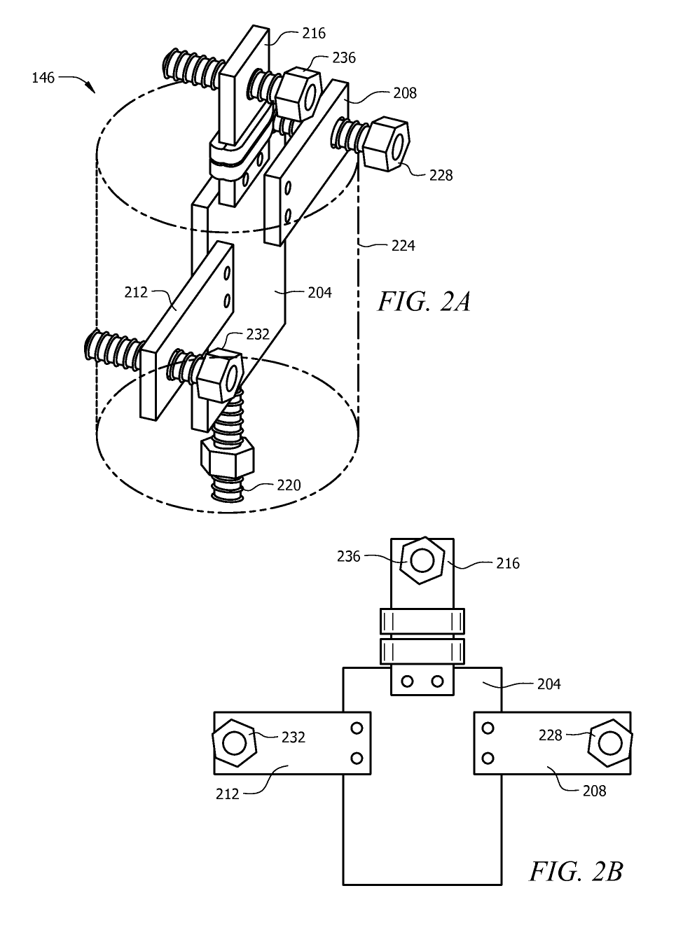

The ground electrode 100 includes an admittance coupler 146 attached to the upper side of the base plate 104. FIGS. 2A and 2B illustrate the admittance coupler 146 in greater detail. The admittance coupler 146 includes a body plate 204. In one embodiment, the body plate 204 is rectangular and is made from a conductive material. The body plate 204 is electrically connected to the base plate 104 via a threaded rod or a wire. Alternatively, wires may be used to facilitate the connection between the base plate 104 and the body plate 204. The body plate 204 is positioned generally perpendicular to the base plate 104.

The admittance coupler 146 includes two arm plates 208 and 212 electrically connected to the body plate 204. In one embodiment, the arm plates 208 and 212 are rectangular-shaped. In one embodiment, the body plate 204 is vertically oriented while the arm plates 208 and 212 are laterally oriented in relation to the body plate 204. The arm plates 208 and 212 are bolted to the body plate 204 via threaded rods. Alternatively, wires may be used to facilitate the connection between the arm plates 208 and 212 and the body plate 204.

The admittance coupler 146 includes a head plate 216 electrically connected to the body plate 204. The connection between the head plate 216 and the body plate 204 may be facilitated by a threaded rod or alternatively by wires. In one embodiment, the admittance coupler 146 is positioned proximate the geometric center of the base plate 104. In one embodiment, the body plate 204 is larger than the arm plates 208 and 212 and the head plate 216.

In one embodiment, the admittance coupler 146 may include an irregular-shaped plate instead of the body plate, two arm plates and a head plate. In other words, the body plate, the two arm plates and the head plate may be replaced by an irregular-shaped plate.

In one embodiment, a housing 224 partially encloses the admittance coupler 146. In one embodiment, the housing 224 is cylindrical-shaped. The body plate 204 is positioned inside the housing 224 but portions of the arm plates 208 and 212 and the head plate 216 extend out of the housing 224. In one embodiment, the arm plates 208 and 212 and the body plate 216 each include a threaded throughbore for receiving respective threaded rods 228, 232 and 236. The threaded rods 228, 232 and 236 are used to facilitate electrical connection between the ground electrode 100 and a structure.

In one embodiment, the housing 224 is made from polyvinyl chloride (PVC) or other suitable material.

The ground electrode 100 includes three diffusers 120, each circumferentially wrapping a section of a respective tube. In one embodiment, the diffusers 120 are frustum-shaped and are formed of a conductive material. In yet another embodiment, the diffusers 120 are ring-shaped.

In other embodiments, the base plate may be rectangular, circular or may have other suitable shapes. In other embodiments, the ground electrode may have a plurality of tubes (e.g., 4, 5), each having a first and a second end. The first ends are connected to the lower side of the base plate and the second ends converge in the circular base of a cone.

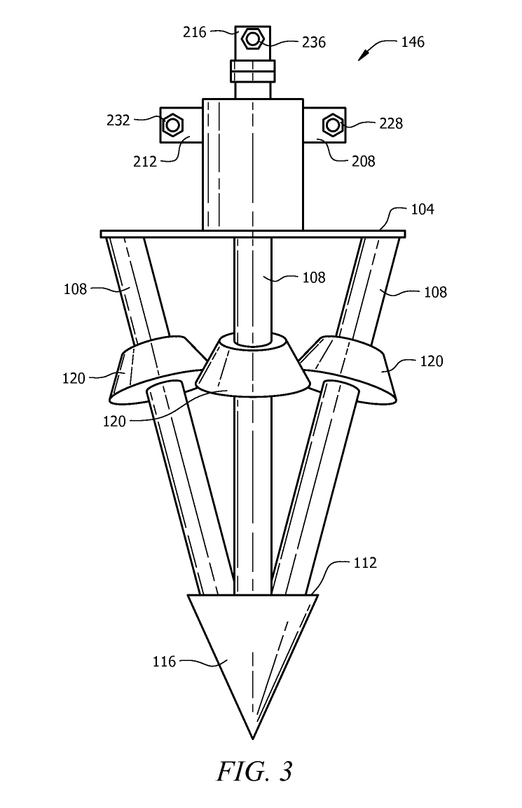

FIG. 3 illustrates a side view of the ground electrode 100 in accordance with one embodiment.

Prior to installation of the ground electrode 100, a suitable grounding point is determined. A cavity of sufficient dimensions is made for housing the ground electrode 100. In the cavity bottom, a soil conditioning composite is deposited. The soil conditioning composite may be a mixture of mineral coal and cement. The soil conditioning composite is used to reduce the resistance of the ground and to increase the grounding capacity of the ground electrode 100.

The ground electrode 100 is then partially buried in the cavity so that the tip 150 of the cone 116 is downward. The arm plates 208 and 212 and the head plate 216 are electrically connected to a building or a structure. The threaded rods 228, 232 and 236 may be electrically connected to the building via wires to facilitate connection between the building and the ground electrode 100.

In operation, current generated in a building or a structure due to short circuit, atmospheric discharge, induction or other conditions flows into the ground via the ground electrode 100. The pyramid-shaped configuration of the ground electrode 100 creates a path for current to flow into the ground. More specifically, tubes 108, the cone 116 and the diffusers 120, in addition to the other elements of the ground electrode 100, increase its grounding capability.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of embodiments. Accordingly, it is appropriate that the appended claims be construed broadly and in a manner consistent with the scope of the invention.

1. A ground electrode, comprising:
a triangular base plate having an upper and a lower side;
three tubes each having a first and a second end, the first ends connected to the lower side of the triangular base plate, the tubes tilted so that the second ends converge in the circular base of a cone; and
an admittance coupler attached to the upper side of the triangular base plate, the admittance coupler comprising:
a housing;
a body plate positioned in the housing and electrically connected to the triangular base plate;
two arm plates connected to the body plate, a portion of the arm plates protruding from the side of the housing;
a head plate connected to the body plate, a portion of the head plate protruding from the top of the housing; and
three diffusers each circumferentially wrapping a section of a respective tube.

2. The ground electrode of claim 1, wherein the diffusers are frustum-shaped formed of conductive material.

3. The ground electrode of claim 1, wherein the diffusers are rings formed of conductive material.

4. The ground electrode of claim 1, further comprising a respective threaded throughbore in the two arm plates and the head plate for receiving a respective threaded rod.

5. The ground electrode of claim 1, wherein each tube is connected to one of the three vertices of the triangular plate.

6. The ground electrode of claim 1, wherein the triangular plate is made from copper.

7. The ground electrode of claim 1, wherein the triangular plate is made from a conductive material.

8. The ground electrode of claim 1, wherein the body plate is connected to the triangular plate via a conductive rod.

9. The ground electrode of claim 1, wherein the housing is a hollow cylinder made from a dielectric material.

10. The ground electrode of claim 1, wherein the housing is a hollow cylinder made from PVC.

11. The ground electrode of claim 1, wherein the cone is solid.

12. The ground electrode of claim 1, wherein the tubes are solid.

13. The ground electrode of claim 1, wherein the admittance coupler is positioned proximate to the center of the triangular plate.

14. The ground electrode of claim 1, wherein the triangular plate is positioned approximately parallel to the ground.

15. The ground electrode of claim 1, wherein the body plate is positioned vertical in relation to the triangular plate.

16. The ground electrode of claim 1, wherein the plates are rectangular.

17. A ground electrode, comprising:
a rectangular base plate having an upper and a lower side;
four tubes each having a first and a second end, the first ends connected to the lower side of the rectangular base plate, the tubes tilted so that the second ends converge in the circular base of a cone; and
an admittance coupler attached to the upper side of the rectangular base plate, the admittance coupler comprising:
a housing;
a body plate positioned in the housing and electrically connected to the rectangular base plate;
two arm plates connected to the body plate, a portion of the arm plates protruding from the side of the housing; and
a head plate connected to the body plate, a portion of the head plate protruding from the top of the housing;

19. A ground electrode, comprising:
a triangular base plate having an upper and a lower side;
three tubes each having a first and a second end, the first ends connected to the lower side of the triangular base plate, the tubes tilted so that the second ends converge in the circular base of a cone; and
an admittance coupler attached to the upper side of the triangular base plate, the admittance coupler comprising:
a body plate positioned in the housing and electrically connected to the triangular base plate;
two arm plates connected to the body plate;
a head plate connected to the body plate; and
three diffusers each circumferentially wrapping a section of a respective tube.

20. A ground electrode, comprising:
a base plate having an upper and a lower side;
a plurality of tubes each having a first and a second end, the first ends connected to the lower side of the base plate, the tubes tilted so that the second ends converge in the circular base of a cone; and
an admittance coupler attached to the upper side of the base plate, the admittance coupler comprising:
a body plate electrically connected to the base plate;
two arm plates connected to the body plate;
a head plate connected to the body plate; and
a plurality of diffusers each circumferentially wrapping a section of a respective tube.

21. The ground electrode of claim 20, wherein the base plate is circular.

22. The ground electrode of claim 20, wherein the diffusers are frustum-shaped formed of conductive material.

23. The ground electrode of claim 20, wherein the diffusers are rings formed of conductive material.

24. The ground electrode of claim 20, further comprising a respective threaded throughbore in the two arm plates and the head plate for receiving a respective threaded rod.

25. The ground electrode of claim 20, wherein each tube is connected to one of the vertices of the base plate.

26. The ground electrode of claim 20, wherein the base plate is made from copper.

27. The ground electrode of claim 20, wherein the base plate is made from a conductive material.

28. The ground electrode of claim 20, wherein the body plate is connected to the base plate via a conductive rod.

29. The ground electrode of claim 20, wherein the cone is solid.

30. The ground electrode of claim 20, wherein the tubes are solid.

31. The ground electrode of claim 20, wherein the admittance coupler is positioned proximate to the geometric center of the base plate.

32. The ground electrode of claim 20, wherein the base plate is positioned approximately parallel to the ground.

33. The ground electrode of claim 20, wherein the body plate is positioned vertical in relation to the triangular plate.

33. The ground electrode of claim 20 wherein the arm plates, the head plate and the body plate are rectangular.
